(19) United States
(12) Patent Application Publication
(10) Pub. No.: US 2007/0026368 A1
(43) Pub. Date: Feb. 1, 2007

(54) METHOD FOR ENHANCING CUSTOMER LOYALTY OR SATISFACTION BY ENHANCING EMOTIONAL COMPETENCE AND LEARNING TRANSFERENCE THEREOF

(76) Inventor: John L. Avella, New York, NY (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 11/465,431

(22) Filed: Aug. 17, 2006

Related U.S. Application Data
(63) Continuation-in-part of application No. 11/076,302, filed on Mar. 9, 2005, now abandoned.

(51) Int. Cl. G09B 19/00

(52) U.S. Cl. 434/236

(57) ABSTRACT

Particular aspects provide methods for enhancing customer satisfaction and/or loyalty with respect to customer-driven entities, and more particularly to novel methods for improving customer satisfaction and/or loyalty by enhancing the emotional competence of entity personnel, and by enhancing learning transference or application of the enhanced emotional competence to customer-contact job-tasks. Particular aspects comprise: identifying a customer-driven entity having participant personnel having customer-contact job-tasks; assessing the customer-contact participants, using an emotional competency assessment tool and at least one Human assessment tool expert; participating, by the customer-contact participants, in contract learning activity suitable to provide for learning of enhanced emotional competency skill or proficiency; and applying, by the customer-contact participants and with facilitation by a Human expert, the enhanced skill or proficiency to customer-contact job-tasks, wherein establishing enhanced customer satisfaction and customer loyalty is afforded. Additional aspect provide assessment kits for practicing the inventive methods.

### CROSS-REFERENCE TO RELATED APPLICATIONS

The present application is a continuation-in-part of U.S. application Ser. No. 11/067,302, filed 09 May 2005, which is incorporated by reference herein in its entirety.

### FIELD OF THE INVENTION

Particular aspects relate generally to methods for improving customer satisfaction and/or loyalty with respect to customer-driven entities (e.g., including, but not limited to service or business entities), and more particularly to novel methods for improving customer satisfaction and/or loyalty by enhancing the emotional competence of entity personnel, and by enhancing learning transference or application of the enhanced emotional competence to customer-contact job-tasks.

### BACKGROUND

Measures of IQ and emotional IQ/intelligence (‘EQ’ or ‘EI’). There have been three major general approaches to assessment of emotional IQ or intelligence EI represented by the work of: Reuven Bar-On (2000; directed to subjective well-being, and non-intellective aspects of performance); Daniel Goleman (1995; predicated on studies of the psychologist David McClelland); and Jack Mayer and Peter Salovey (1997; assessments and consulting in cognition and affect and its various applications). The corresponding three validated major EQ assessment instruments are the BarOn EQi® assessment, the MSCEIT™ assessment, and the Emotional Competence Inventory (ECI™) assessment, respectively. Additional assessment instrument examples, although less recognized or validated, include the EQ-Map™, ESSE™, and 6-seconds Emotional Intelligence Assessments.

BarOn EQ-i® self-report. The BarOn EQi® assessment instrument, developed by Reuven BarOn, is a ‘self-report’ assessment, which means that the participant evaluates him or her self by answering 125 questions. This assessment is used to measure an array of noncognitive capacities, competencies and skills that influence one's abilities to succeed in coping with environmental demands and pressures. Based on twenty years of research by Dr. Reuven Bar-On and completed by approximately 110,000 individuals worldwide, the BarOn EQ-i® self-report is the premier scientific measure of self-report social emotional intelligence. The BarOn EQ-i® and BarOn EQ-i:S™ assessments measure one's self-reported potential to deal with daily environmental demands and pressures, and help predict one's success in both professional and personal pursuits. The EQi is divided into five sections: Intrapersonal, which includes self-awareness, assertiveness, independence, and self-actualization; Interpersonal, which includes empathy, social responsibility and approachability; Stress management, which includes stress tolerance and impulse control; Adaptability, which includes flexibility, reality testing and problem solving; and the fifth section Mood, which includes optimism and happiness.

MSCEIT™. The MSCEIT™ assessment instrument was developed by Mayer, Salovey and Caruso, and follows the theory that emotional intelligence is an intelligence per se, in that it relates to processing information. The assessment asks the participants to perceive various emotions in faces, music and stories. The MSCEIT™ measures the capacity to reason using feelings, and the capacity of feelings to enhance thought. MSCEIT™ is an ability-based scale that measures how well people perform tasks and solve emotional problems as opposed to relying on an individual's subjective assessment of their perceived emotional skills. The assessment covers these four areas: emotional perception; emotional facilitation; emotional understanding: and emotional management.

ECI™. ECI™, developed by Goleman, Boyatzis and Hay/McBer, is a ‘360 assessment,’ which means the participant will be evaluated by themselves, three of their peers, subordinate if any and their immediate supervisor. This type of assessment is a very good measure of behavior except in the case of new employees. This assessment measures four aspects of EQ: Self-awareness which includes emotional self-awareness, self confidence and self-assessment; Self-management which includes self-control, adaptability and initiative; Social awareness which measures empathy, and service orientation; and Social skills that include leadership, influence, change catalyst, communication and conflict management.

IQ and emotional IQ/intelligence (‘EQ’ or ‘EI’) as a performance predictor; negative consequences of ignoring EQ (EI). There is a continuing debate as to whether emotional IQ (“EQ” or “EI”) or IQ is a better predictor of workplace performance or success in the marketplace. In one sense, this debate/question is purely academic because cognitive abilities and emotional intelligence always interplay, but in another sense, the debate and the answer to this question has practical implications for significant workplace decisions (Daniel Golman; The Emotionally Intelligent Workplace . . . ). For example, selection of high-level executives solely on their academic intelligence and business expertise and ignoring their emotional intelligence often leads to poor choices that can be disastrous for an organization (Id, discussing implications of the Claudio Fernandez-Araoz). There is an evolving basis in the marketplace that sustains the proposition that both EI and IQ make separate and discrete contributions to performance, which is consistent with the poor correlation between IQ and EI; showing a range of from 0 to 0.36 depending on the measures used (e.g., Reuven Bar-On has found correlations ranging from 0.06 to 0.12, which are positive but not significant).

Power of EQ (EI) versus IQ as a performance predictor within organizations, and particularly at upper management levels. No longitudinal studies have yet been conducted to assess the predictive power of EI relative to IQ in distinguishing workplace performance over the course of a career, and only a few studies (e.g., Dulewicz and Higgs in 1998; Boyatzis in 1982) have been performed longitudinally in attempting to compare the contribution of cognitive competencies and EI competencies as gauged by promotions. Nonetheless, the emerging view is that while IQ is regarded as a stronger predictor than EI with respect to which jobs and professions people can enter (where IQ acts as a proxy for the cognitive complexity a person can process), once in a profession, EQ (EI) provides a better performance predictor, particularly at higher organizational levels, and in particular fields (Goleman, supra). Thus, having enough cognitive intelligence to maintain a job in a given field does not necessarily predict outstanding performance or ascension to management or leadership positions in a field, and among distinguishing competencies in particular occupations, emotional competencies (EQ, EI) are twice as prevalent as are technical and purely cognitive abilities combined (Id). Generally, the higher the position in an organization, the more pronounced EI factored as a predictive mechanism. Among management positions, 85% of the competencies were in the EI domain (Id). This is partly because at higher organizational levels, and in particular fields (e.g., engineering, law, etc.) technical or cognitive competencies are considered requisite, threshold skills, and are thus less significant differentiators between average and outstanding performers. Therefore, in organizations throughout the world, EQ (EI) competency models are increasingly regarded as highly consequential predictors that guide decisions not only on initiating employment, but also for tracking performance of individuals within a professional role or position, and for advancement, promotion, and establishing leadership building priorities within management structures.

Longstanding deficiency in the art. Despite, as discussed above, the emergence of EQ (EI) theories and an increasing appreciation of the value of EQ (EI) as a performance predictor among individuals within a profession or complex organization (e.g., corporations, service organizations, etc.), there is a lack of knowledge and understanding of how to effectively leverage EQ (EI) competencies to enhance external aspects that affect commercial viability. For example there is a pronounced and long-standing need in the art to enhance the interface between customer-driven organizations and the customers that they serve and rely on for viability and/or commerce. This deficiency in the art is additionally and significantly compounded by the fact that there is currently no specific preferred or targeted ‘profiles’ (e.g., emotional, or behavioral characteristic profile or style, etc.) to enable guided or targeted behavior modification of such customer-contact individuals to enhance respective customer satisfaction or loyalty. For example, while U.S. Pat. No. 6,439,893 to Byrd et al., describes a web-based system for assessing, monitoring and modifying behavioral characteristics by selecting and training toward a targeted profile from a growth strategy matrix comprised of a set of alternate model selectable target profiles, such methods provide no guidance or reasonable expectation of utility with respect to leveraging EQ (EI) to enhance customer satisfaction and/or loyalty, because there is, in fact, no known specific preferred or targeted ‘profiles’ (e.g., behavioral characteristic, profile or style, etc.) that have been associated with enhancing customer satisfaction and/or loyalty.

There is, therefore, a pronounced need in the art for novel and effective methods to enhance the quality of the interactions between customers and those customer-contact individuals within customer-driven organizations that have direct customer contact. There is a pronounced need in the art, particularly within complex entities (e.g., organizations and corporations with complex management/reporting structures), to enhance and affect EQ (EI) ‘learning transference’ and ‘skill transference’ from customer-contact individuals with the organization to the customer relation jobs and job-tasks that they perform. There is a pronounced need in the art for novel and effective methods to enhance customer satisfaction. There is a pronounced need in the art for novel and effective methods to enhance customer loyalty.

### SUMMARY OF THE INVENTION

Particular aspects provide novel methods for improving customer satisfaction and/or loyalty with respect to customer-driven entities (e.g., service or business entities).

Preferred aspects provide novel methods for improving customer satisfaction and/or loyalty by enhancing the emotional competence of, and enhancing earning transference by customer-contact persons to their respective customer-contact job-tasks.

Particular aspects facilitate EQ (EI) learning transference in the context of customer relations, satisfaction or loyalty by involving both customer-contact individuals and managers/supervisors of such individuals in the process so that the organization/entity/corporation is receptive to, and allows for learning transference of newly-acquired skills to the customer-contact job-tasks that actually affect customer relations, satisfaction or loyalty. The novel methods are particularly important and have substantial utility, because there is currently no preferred or ideal target ‘profile’ for customer-contact persons that would be expected to enhance customer relations and/or satisfaction. Likewise, application of prior art behavior (behavior characteristics, style, etc.) modification models (e.g., Byrd et al.) based on such target profiles are not effective for these utilities.

Particular aspects provide a method for enhancing at least one of customer satisfaction and customer loyalty, comprising: identifying a customer-driven entity having a personnel management structure and having participant personnel comprising at least one managed or supervised customer-contact participant having customer-contact job-tasks, and at least one managerial or supervisory participant who manages or supervises, or who contributes to managing or supervising of the at least one customer-contact participant; assessing the at least one customer-contact participant, using an emotional competency assessment tool and at least one Human assessment tool expert having expert knowledge of the assessment tool, to provide for assessment results and a respective set of developmental requirements derived by the at least one assessment tool expert based on the emotional competency assessment results; participating, by the at least one customer-contact participant, in at least one contract learning activity suitable to provide for learning of enhanced skill or proficiency in at least one developmental requirement of the respective set of developmental requirements; and applying, by the at least one customer-contact participant, the enhanced skill or proficiency to the at least one customer-contact job-task, wherein at least one of establishing enhanced customer satisfaction and customer loyalty is, at least in part, afforded, and wherein said applying comprises facilitation by at least one Human learning transference expert having expert knowledge in promoting transference of the enhanced skill or proficiency to the at least one customer contact job-task.

Additional aspects provide a method for enhancing at least one of customer satisfaction and customer loyalty, comprising: identifying a customer-driven entity having a management and having participant personnel comprising at least one managed or supervised customer-contact participant having customer-contact job-tasks, and at least one managerial or supervisory participant who manages or supervises, or who contributes to managing or supervising of the at least one customer-contact participant; obtaining authorization or endorsement from the management of the customer-driven entity to assess the at least one customer-contact participant using an emotional competency assessment means; assessing, using the emotional competency assessment means, the at least one customer-contact participant to provide for respective assessment results; evaluating, with assistance of Human assessment means expert having expert knowledge of the assessment means, the assessment results to provide a respective set of emotional competency developmental requirements; communicating the set of developmental requirements to the respective at least one customer-contact participant; developing, with participation of the at least one customer-contact participant and using the respective set of emotional competency developmental requirements, a respective learning contract comprising a set of learning activities selected from a matrix of available learning activities suitable to provide for learning of enhanced skill or proficiency in at least one developmental requirement of the respective set of developmental requirements; directing the at least one customer-contact participant to at least one contract learning activity to provide for learning, by the at least on customer-contact participant, of enhanced skill or proficiency in at least one developmental requirement of the respective set of developmental requirements; applying, by the at least one customer-contact participant, the enhanced skill or proficiency to the at least one customer-contact job-task, wherein at least one of establishing enhanced customer satisfaction and customer loyalty is, at least in part, afforded, and wherein said applying comprises facilitation by at least one Human learning transference expert having expert knowledge in promoting transference of the enhanced skill or proficiency to the at least one customer contact job-task.

In particular aspects facilitation, by the at least one Human learning transference expert, of the application of the enhanced skill or proficiency to the at least one customer contact job-task comprises assembling a plurality of participants in a group to discuss successful strategies, progress or obstacles in the application of the enhanced skill or proficiency to the at least one customer contact job-task. In additional aspects, facilitation, by the at least one Human learning transference expert, of the application of the enhanced skill or proficiency to the at least one customer contact job-task comprises reducing or eliminating impediments or obstacles to said application that are inherent to the personnel management structure or to the managerial or supervisory relationship between the at least one managed or supervised customer-contact participant and the at least one managerial or supervisory participant who manages or supervises, or contributes to managing or supervising of the at least one customer-contact participant.

### BRIEF DESCRIPTION OF THE DRAWINGS

FIG. 1 shows a Flow Chart of an exemplary enhanced customer satisfaction and/or loyalty implementation according to preferred aspects of the present invention.

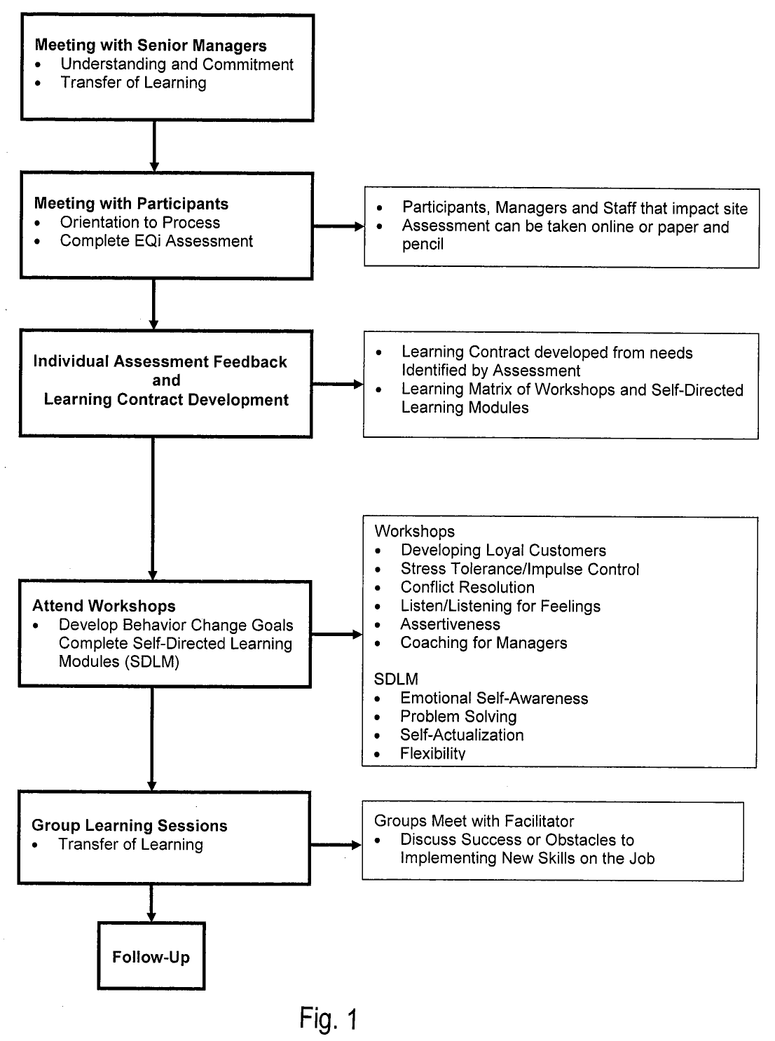

### DETAILED DESCRIPTION OF THE INVENTION

Particular aspects provide, for the first time, novel and highly effective methods for improving customer satisfaction and/or loyalty with respect to customer-driven entities (e.g., service or business entities), comprising enhancing the emotional competence (e.g., EQ, EI) skills of customer-contact persons, and facilitating learning transference (effective application) of the skills by customer-contact persons to enhance customer-contact job-tasks, which in turn improves customer satisfaction and/or loyalty. The present inventive aspects are surprising, and were not suggested by the prior art, because not only was it not known that emotional competence (e.g., EQ, EI) skill acquisition could be effectively applied or leveraged for customer satisfaction and/or loyalty, but the existence and nature of barriers or impediments to such application or leveraging were also not understood or appreciated. In fact, the prior art indirectly ‘teaches away’ from such leveraging, because no preferred target behavior characteristic ‘profiles’ have been identified for enhancing customer satisfaction and/or loyalty.

The present conception and inventive aspects not only encompasses effectively leveraging emotional competence (e.g., EQ, EI) skills to improve customer satisfaction and/or loyalty, but also encompass the applicant's conception that barriers or impediments to ‘learning transference’ (application of acquired emotional competence skills to job-tasks relating to customer contact) are inherent to the management or supervisory dynamics or ‘culture’ of customer-driven entities, and removal of such cultural barriers or impediments is a critical aspect for achieving learning transference of acquired emotional competence (e.g., EQ, EI) skills to job-tasks that improve customer satisfaction and/or loyalty.

Preferred aspects, as described herein, facilitate learning transference of acquired emotional competence (EQ, EI) skills by involving both customer-contact individuals and managers/supervisors in the process so that the organization/entity/corporation is receptive to, and allows for learning transference of newly-acquired skills to the customer-contact job-tasks that actually affect customer relations, satisfaction or loyalty. As disclosed herein, the present novel inventive aspects have been shown to be surprisingly effective in enhancing customer satisfaction and/or loyalty, and therefore represent a substantial contribution to the art.

Definitions:

“Customer-driven entity,” as used herein refers to any organization, business, company, corporation, institution, governmental body, health service provider, hospitality-based entity, or any entity, business model or organizational model, which provides a service, product or benefit to its customers, and therefore benefits from customer satisfaction and/or loyalty. Customer-driven entities include, but are not limited to entities that provide some sort of product or service (e.g., for sale) or other aspect desired by customers or consumers thereof.

“Customer loyalty” or ‘customer satisfaction” as used herein broadly refers, inter alia, to the disposition of a customer (e.g., patron, client, purchaser, buyer, shopper, consumer, guest, employee, staff member, manager, etc.) to positively regard the entity and/or its members/participants. For example customer satisfaction might be expressed and gauged by such measures as repeat patronage, willingness to pay an increased amount for the service or product, to promote a service, product or entity or its members. Customer loyalty applies in the context of both external and internal manifestation. External customers are generally those outside the entity that benefit from the entity's service or product. Internal customers are generally individuals within the entity itself, and who provide a service or product to other entity personnel. For example, staff personnel are in some respects customers of management personnel, and management personnel are in some respects customers for stall personnel. Internal customer satisfaction or loyalty can be measured or gauged, for example, by management and staff employee satisfaction, management and staff employee retention, management and staff employee performance levels, internal promotion of the entity and its culture by management and staff employees, etc. In particular embodiments, customers are internal. In particular embodiments, customers are external. Particular embodiments comprise both internal and external customers.

“Participants” as used herein refers to those individuals within a customer-driven entity that are engaged to participate in the inventive methods for enhancing customer satisfaction and/or loyalty. Participants includes, but is not limited to ‘customer-contact participants” who interface with customers of the entity in performing client-contact job-tasks. Participants also includes, but is not limited to “managerial participants” or “supervisory participants” who manage or supervise, or who contribute to the management and supervision of, respectively, the customer-contact participants. In particular embodiments, certain managerial and/or supervisory participants may additionally be client contact participants.

“Emotional competency,” “emotional intelligence (EI)” or “emotional IQ (EQ),” as used herein refers to a state of emotional competency, for example, reflecting the proficiency status of a set of EQ- or EI-related or defined learning requirements.

An “Emotional competency assessment” “emotional intelligence (EI) assessment” or “emotional IQ (EQ) assessment,” as used herein refers to an assessment method (e.g., tool, test, inventory, questionnaire, etc.) designed to identify ‘learning requirements’ for which the assessed individual may choose to acquire enhanced proficiency to improve or achieve emotional competency. The learning requirements reflect the assessed individual's emotional intelligence levels in areas including, but not limited to: intrapersonal (which includes self-awareness, assertiveness, independence, and self-actualization); interpersonal (which includes empathy, social responsibility and approachability); stress management (which includes stress tolerance and impulse control); adaptability (which includes flexibility, reality testing and problem solving); mood (which includes optimism and happiness); emotional perception; emotional facilitation; emotional understanding; emotional management; self-awareness (which includes emotional self-awareness, self confidence and self-assessment); self-management (which includes self-control, adaptability and initiative); social awareness (which measures empathy, and service orientation); and social skills (that include leadership, influence, change catalyst, communication and conflict management).

A “developmental requirement” or “set of developmental requirements,” relating to emotional competency (EI, EQ) assessment results, as used herein refers to an emotional competency (EI, EQ) level, deficit or need, or to a set thereof, that is identifiable by an assessment expert having expert knowledge, as described above, of an emotional competency (EI, EQ) assessment tool (e.g, Reuven Bar-On™ assessment, etc.).

“Contract learning activity” as used herein, refers to a learning activity participated in (e.g., attended, performed, carried out, implemented, completed, accomplished, undertaken, executed, acted on, etc.) by a participant, the activity suitable to provide for acquiring skill or proficiency results by the participant for at least one developmental requirement (e.g., at least one developmental requirement of a respective set of developmental requirements), to provide for enhanced customer-contact job-task skills by the participant. Contract learning activity comprise, for example, workshops and self-directed activities. Workshops comprise training in, for example, at least one of empathy, listening, empathic listening, stress tolerance, stress management, impulse control, assertiveness, conflict resolution, connecting to the customer, and goal setting. Self-directed learning activities comprise training in, for example, at least one skill area selected from the group consisting of emotional self-awareness, self-actualization, flexibility, and problem solving.

A “customer-contact job-task,” as used herein, refers to a job-task performed, with respect to a customer, by at least one customer-contact participant of a customer-driven entity. Such tasks include, but are not limited to interacting with customers, communicating with customers, promoting, selling or otherwise providing goods or services to customers, etc. In particular embodiments, customer contact job tasks are preformed directly (e.g., face-to-face, real-time voice communication, teleconferencing, etc) or indirectly (e.g., written, email, voice mail, etc.). In particular embodiments, customer-contact job tasks comprise face-to-face and/or real-time interaction or communication.

“Facilitator” or “expert,” as used herein, refers to a human expert who assists in at least one of step of the inventive methods, the facilitator having expert knowledge relevant to the respective at least one step (e.g., to the advice, interpretation, etc., being provided). Facilitators assisting in various steps may be the same facilitator, or alternatively different facilitators, provided that they have expert knowledge relevant to the advice, interpretation, etc., being provided in the respective step or steps. Experts include, for example: Human assessment tool experts having expert knowledge of the assessment tool, to provide for a respective set of developmental requirements derived by the assessment tool expert based on the emotional competency assessment results; Human learning transference experts having expert knowledge in promoting transference of enhanced emotional competency skill or proficiency to customer contact job-tasks; Human learning contract experts having expert knowledge of the learning activities, as defined herein, in view of a set of developmental requirements; and Human contract learning activity experts having expert knowledge of the relevance or value of the contract learning activity to the developmental requirements. Again, facilitators assisting in various steps of the methods may be the same facilitator, or alternatively different facilitators.

Reducing or eliminating “impediments,” to application of enhanced skill or proficiency in a developmental requirement, as used herein, refers to reducing the number and/or extent of learning transference impediments that are inherent, within the customer-driven entity culture, for example, to the managerial or supervisory relationship that exists between a managed or supervised customer-contact participant and a managerial or supervisory participant who manages or supervises, or who contributes to managing or supervising of the customer-contact participant. Such impediments include, but are not limited to: lack of, or insufficient support from managers/supervisors for behavioral changes by customer-contact personnel/participants (e.g., “we don't do that here”); resistance by managers/supervisors to change or new approaches; lack of, or insufficient time or opportunity by customer-contact personnel to implement learned emotional competency skills; lack of flexibility in job descriptions, schedules, support structures relating to customer-contact personnel; presence of negative ‘peer pressure’; non-compliance and/or lack of, or insufficient co-operation by managers/supervisors, lack of reasonable incentives for either acquisition of enhanced emotional competency proficiencies and/or learning transference thereof.

“Learning transference” as used herein with respect to enhancing customer satisfaction or loyalty refers to the effective application (e.g., by the learning individual, the entity, by other entity personnel, and by combinations thereof) of acquired emotional competency learning to customer-contact job tasks (e.g., real-word application of the learning).

Method for Enhancing Customer Loyalty or Satisfaction by Enhancing Emotional Competence and Learning Transference Thereof:

Particular aspects provide a system to teach emotional competence which comprises the steps of orienting entity management or supervisor, and/or customer-contact personnel (collectively participants) in a protocol so that they may complete an emotional competency assessment (e.g., a Bar-On EQI™); evaluating results of the assessment (e.g., the Bar-On EQI™); communicating the results to the participants; requesting the participants to develop a learning contract; directing participants to specific workshops indicated by the learning contracts; developing goals in these workshops; and evaluating application of knowledge learned in training process as applied to the job and client contact job-tasks.

Any suitable system may be employed to orient management and participants regarding the protocol to be taught to have them complete the emotional intelligence assessment (e.g., Bar-On EQI™). There are, generally speaking, two parts to this process. The first relates to orienting the managers of the customer-contact personnel participants to the process in order to gain understanding of the process and enable, for example, the management to assist the customer-contact employees in employing emotional competency on the job; and secondly orienting the customer-contact personnel participants so that they can understand the process and the guidelines for taking the Bar-On EQI. Typically, in orienting managers and participants, two paths may be followed, either one relating to orienting the customer-contact personnel participants to the training process or optionally, in choosing not to do so. Participating organizations may choose to orient the managers of the participants but yet provide impediments by not allowing them to develop any plan on how they will assist the customer-contact participants to utilize the new skills on the job. In addition to orienting the participants in a workshop, memos may be suitably drafted to inform the participants in order to explain the process while they are attending the meeting or the participating organizations may choose to provide no information prior to the meeting. As to the participants' orientation, they may either receive a memo relating to the process or their immediate supervisor may inform them of the process or, in the alternative, they may be asked to take the emotional intelligence assessment (e.g., the Bar-On EQI™) without any preparation at all.

Optimally, the participants should understand the process and the guidelines for the assessment and be informed of the confidentiality of the results. Further, the results should not be shared with third parties without the appropriate permission obtained. This confidentiality helps insure and motivate the participants to be very candid in their responses to the assessment.

Any suitable method may be employed to evaluate the results of the emotional intelligence assessment (e.g., the Bar-On EQI™). Typically, the participants take the emotional intelligence assessment (e.g., the Bar-On EQI™) by either employing paper and pencil or on a computer (e.g., on-line over a LAN or WAN). The results are then sent back to a facilitator who provides the participants with feedback. The facilitators are certified, for example in the case of using the Bar-On EQI™ by MHS (the company that owns the rights to the Bar-On EQI™) employing a three day training process and a certification test. The results are evaluated by the facilitator based on the style and protocol employed to evaluate these results. Although most facilitators are trained to evaluate the assessments in an elementary fashion, optimally facilitators should employ their experience and education to transcend the standard (e.g., MHS) criteria. This will require that the facilitators become knowledgeable of the many nuances that are included in the emotional intelligence assessment (e.g., the Bar-On EQI™) and fully understand them so that their evaluations will not be performed on an elementary basis.

Any suitable method may be used to communicate, if desired, the results to the participants. Optimally, a specific protocol may be followed when transmitting feedback regarding the assessment results. It is preferred that this feedback be done on a face-to-face basis in an environment where the possibility of interruptions is eliminated. The results are, for example, prepared in a single paper form with no copies and transmitted to the participants. In other cases, facilitators send the results to participants with an explanation of how to apply and understand the results. In still other cases, participants receive the results and are then interviewed on the telephone. Real-time facilitation means comprise, for example, face-to-face interaction, telephonic interaction, video-conference interaction, interactive real-time computer (e.g., LAN or WAN) dialog, or combinations thereof. Non real-time or non-contemporaneous facilitation means comprise, for example, audio, video, written or graphic media, and combination thereof. In some imbodiments, facilitators share the assessment results with the participant's supervisor without the participant's permission.

Any suitable method may be employed to request the participants to develop a learning contract. Optimally the participants are allowed to develop their own learning contract with assistance from the facilitator. The assessment results provide some direction as to what the learning contract should comprise. Although most participating organizations emphasize application of the new skills to the job alone, it is preferred that an emphasis be given to a methodology for additionally applying the new skills in the participant's personal life. A learning contract is developed from the assessment results and the matrix of learning activities that are available for the participant is outlined. Typically, third parties are not involved in the participant's selection of their learning activities and in most cases participating organizations require that everyone experience all the training. Optimally an individualized process which engages the participants in the learning process and motivates them to learn should be employed. Although typically some facilitators do not use learning contracts and participating companies do not employ learning contracts or develop them or used by the participants, it is highly recommended that the learning contract be employed and developed.

Any suitable method for directing participants to specific workshops and self-directed learning activities indicated by the learning contracts may be employed. In collaboration with the facilitator, typically the participant will choose specific workshops and self-directed learning activities that will match his or her development requirements. These development requirements are identified by the emotional intelligence assessment (e.g., the Bar-On EQI™) and contained in the learning contract. Typical workshops include, but are not limited to: empathy, listening and empathic listening, stress management, impulse control, assertiveness, connecting to the customer and goal setting. The self-directed learning activities typically include, but are not limited to: emotional self-awareness, self-actualization, flexibility and problem solving. In certain embodiments, the participants have a choice of the workshops or other learning activities and the participating companies structure their training to include a choice of learning activities for the participants. In certain embodiments, both workshops and self-directed learning activities are employed. Preferably, in order to eliminate participant disinterest and frustration and to conserve money, the participants, not the supervisors, should decide which workshops to attend. This is particularly true with regard to customer service training where the real problem may be organizational, supervisory or a cultural problem, but where the problem/culture does not dictate that all the front-line staff be trained without regard to their personal requirements.

Any suitable method to develop goals in said workshops may be employed. Typically, most participating organizations educate their participants but do not require any commitment or goal setting in order to modify their behavior. In particular embodiments, the value of the skills are emphasized in the context of the participants' conducting of their personal lives. Additionally, in particular embodiments, goals are linked to a reward system to motivate the participants to accomplish their respective goals. Preferably, the participants and their supervisors share these goals so that they can work together to encourage and support the participant in achieving the goals.

Any suitable method to evaluate results of the participants in workshops in a group forum may be employed. Typically, the participants assemble in a group with a facilitator to discuss their progress or obstacles in using the newly acquired skills on their jobs. This transfer of learning process, for example, occurs when the participants discuss and share successful application strategies, or ways to surmount obstacles to the implementation of the new learning process. Preferably, the participating entities/organizations are informed of any real and/or potential obstacles or impediments to transfer of learning within their entity culture (e.g., management culture) and are encouraged to remove them so that the process may be properly implemented. Reducing or eliminating “impediments,” to application of enhanced skill or proficiency in a developmental requirement preferably involves reducing the number and/or extent of learning transference impediments that are inherent, within the customer-driven entity culture, to the managerial or supervisory relationship that exists between a managed or supervised customer-contact participant and a managerial or supervisory participant who manages or supervises, or who contributes to managing or supervising of the customer-contact participant. Such impediments include, but are not limited to: lack of, or insufficient support from managers/supervisors for behavioral changes by customer-contact personnel/participants (e.g., “we don't do that here”); resistance by managers/supervisors to change or new approaches; lack of, or insufficient time or opportunity by customer-contact personnel to implement learned emotional competency skills; lack of flexibility in job descriptions, schedules, support structures relating to customer-contact personnel; presence of negative ‘peer pressure’; non-compliance and/or lack of, or insufficient co-operation by managers/supervisors.

Exemplary Preferred Embodiments:

In certain particular aspects, the scope of the invention is intended to teach emotional competence comprising: (a) orienting management and participants in a protocol to be taught for the completion of an emotional competence assessment means (e.g., BAR-ON EQI™); (b) evaluating results of the emotional competence assessment means (e.g., BAR-ON EQI™); (c) communicating said results to participants; (d) requesting participants to develop a learning contract as defined herein; (e) directing participants to specific workshops, as defined herein, indicated by said learning contracts; (f) developing goals in said workshops; and (g) evaluating results of participation in workshops in a group forum.

Additional preferred aspects provide a method for enhancing at least one of customer satisfaction and customer loyalty, comprising: identifying a customer-driven entity having a personnel management structure and having participant personnel comprising at least one managed or supervised customer-contact participant having customer-contact job-tasks, and at least one managerial or supervisory participant who manages or supervises, or who contributes to managing or supervising of the at least one customer-contact participant; assessing the at least one customer-contact participant, using an emotional competency assessment tool and at least one Human assessment tool expert having expert knowledge of the assessment tool, to provide for assessment results and a respective set of developmental requirements derived by the at least one assessment tool expert based on the emotional competency assessment results; participating, by the at least one customer-contact participant, in at least one contract learning activity suitable to provide for learning of enhanced skill or proficiency in at least one developmental requirement of the respective set of developmental requirements; and applying, by the at least one customer-contact participant, the enhanced skill or proficiency to the at least one customer-contact job-task, wherein at least one of establishing enhanced customer satisfaction and customer loyalty is, at least in part, afforded, and wherein said applying comprises facilitation by at least one Human learning transference expert having expert knowledge in promoting transference of the enhanced skill or proficiency to the at least one customer contact job-task.

In particular embodiments, facilitation by the at least one Human learning transference expert, comprises assembling a plurality of participants in a group to discuss successful strategies, progress or obstacles in the application of the enhanced skill or proficiency to the at least one customer contact job-task. In certain embodiments, facilitation by the at least one Human learning transference expert, of the application of the enhanced skill or proficiency to the at least one customer contact job-task comprises reducing or eliminating impediments or obstacles to said application that are inherent to the personnel management structure or to the managerial or supervisory relationship between the at least one managed or supervised customer-contact participant and the at least one managerial or supervisory participant who manages or supervises, or contributes to managing or supervising of the at least one customer-contact participant. In some embodiments, facilitating in by the at least one Human learning transference expert comprises evaluating, by the expert, the at least one customer-contact participant to identify at least one impediment or obstacle to application or learning transference of the enhanced skill or proficiency to the at least one customer contact job-task. In certain embodiments, facilitating by the at least one Human learning transference expert further comprises evaluating or confronting at least one managerial or supervisory participant with respect to the at least one identified impediment or obstacle to learning transference of the acquired skill or proficiency results. Preferably, facilitating in d) by the at least one Human learning transference expert comprises separately evaluating the at least one customer-contact participant and the at least one managerial or supervisory participant to promote candor. In particular aspects, the at least one impediment or obstacle to application or learning transference of the enhanced skill or proficiency to the at least one customer contact job-task comprises inflexibility or non-compliant or non-supportive behavior by the at least one managerial or supervisory participant. In certain embodiments, the method further comprises, prior to participating in learning activities, communicating the set of developmental requirements to the respective at least one customer-contact participant.

In particular embodiments, the method further comprises, prior to participating in learning activities and after communicating the set of developmental requirements, developing a respective learning contract for the at least one customer-contact participant, the learning contract comprising a set of learning activities selected from a matrix of available learning activities suitable to provide for learning of enhanced skill or proficiency in at least one developmental requirement of the respective set of developmental requirements. Preferably, developing a respective learning contract for the at least one customer-contact participant is by, or comprises input from the at least one customer-contact participant and using the respective set of developmental requirements. In certain embodiments, developing a respective learning contract for the at least one customer-contact participant is by, or comprises assistance from a Human learning contract expert having expert knowledge of the learning activities and using the respective set of developmental requirements.

Additional aspects of the method further comprise, after developing the learning contract, directing the at least one customer-contact participant to at least one contract learning activity of the set of learning activities to provide for learning of enhanced skill or proficiency in the at least one developmental requirement of the respective set of developmental requirements. Preferably, directing the at least one customer-contact participant to the at least one contract learning activity is self-directing by the at least one customer-contact participant. In some embodiments, directing the at least one customer-contact participant to the at least one contract learning activity is by, or assisted by a Human contract learning activity expert having expert knowledge of the relevance or value of the at least one contract learning activity to the at least one developmental requirement.

In preferred embodiments, the method further comprises at least one of: assessing; participating in learning activities; and applying is additionally with respect to the at least one managerial or supervisory participant. Preferably, both customer-contact personnel and management/supervisory personnel are involved in the method steps. Particular aspects of the method comprise prior to assessing, obtaining authorization or endorsement from the customer-driven entity to assess the at least one customer-contact participant using the emotional competency assessment tool. In certain aspects, obtaining authorization or endorsement additionally comprises obtaining authorization or endorsement from the customer-driven entity to assess the at least one managerial or supervisory participant, and wherein at least one of assessing, participating, and applying is additionally with respect to the at least one managerial or supervisory participant. In certain embodiments, obtaining authorization or endorsement additionally comprises explaining at least one of assessing, participating, and applying to the at least one managerial or supervisory participant and to the at least one managed or supervised customer-contact participant to facilitate application or learning transference of the enhanced skill or proficiency in at least one developmental requirement to the respective customer-contact job-tasks. In particular aspects, obtaining authorization or endorsement additionally comprises explaining, to the at least one customer-contact participant, guidelines for emotional competency assessment using an emotional competency assessment tool.

In particular embodiments, the assessment tool expert and the learning transference expert are the same Human expert. In alternate embodiments, the assessment tool expert and the learning transference expert are different Human experts. In certain embodiments, the assessment tool expert, learning transference expert and contract learning activity expert are the same Human expert. In some embodiments, at least two from among the assessment tool expert, learning transference expert and contract learning activity expert are the same or different Human experts.

In particular embodiments of the method, the at least one contract learning activity comprises at least one activity selected from the group consisting of workshops and self-directed activities. In certain aspects, the workshops comprise training in at least one skill area selected from the group consisting of empathy, listening and empathic listening, stress tolerance, stress management, impulse control, assertiveness, conflict resolution, and connecting to the customer. In particular aspects, the self-directed learning activities comprise training in at least one skill area selected from the group consisting of emotional self-awareness, self-actualization, flexibility, and problem solving.

In particular embodiments, the at least one contract learning activity comprises developing at least one goal for application, by the at least one customer-contact participant, of the enhanced skill or proficiency in at least one developmental requirement to the respective customer-contact job-tasks. In certain embodiments, at least one of developing the at least one goal and achieving the at least one goal comprises participation by the at least one managerial or supervisory participant. In some embodiments, developing the at least one goal for the at least one customer-contact participant is by, or assisted by a Human contract learning activity expert having expert knowledge of the relevance or value of the at least one contract learning activity to the at least one developmental requirement or to the respective customer-contact job-tasks. Preferably, the at least one goal is set pursuant to a motivational reward system to facilitate goal achievement. In certain embodiments, the at least one goal is shared by the at least one managerial or supervisory participant to facilitate goal achievement. Certain embodiments comprise developing, in the workshops and/or self-directed activities, goals for application, by the at least one customer-contact participant, of the enhanced skill or proficiency in at least one developmental requirement to the respective customer-contact job-tasks.

In certain embodiments, assessing using an emotional competency assessment tool comprises use of at least one means selected from the group consisting of BarOn EQ-i®, MSCEIT™ and ECI™, as defined herein. Preferably, assessing using an emotional competency assessment tool comprises use of the BarOn EQ-i®, as defined herein.

In certain embodiments, assessing using the assessment tool comprises on-line use of a computer interface. In some embodiments, assessing using the assessment tool comprises use of a local area network (LAN) or a wide-area network (WAN).

need description for facilitating at the various points by other than by face to face.

Additional aspects provide a method for enhancing at least one of customer satisfaction and customer loyalty, comprising: identifying a customer-driven entity having a management and having participant personnel comprising at least one managed or supervised customer-contact participant having customer-contact job-tasks, and at least one managerial or supervisory participant who manages or supervises, or who contributes to managing or supervising of the at least one customer-contact participant; obtaining authorization or endorsement from the management of the customer-driven entity to assess the at least one customer-contact participant using an emotional competency assessment means; assessing, using the emotional competency assessment means, the at least one customer-contact participant to provide for respective assessment results; evaluating, with assistance of Human assessment means expert having expert knowledge of the assessment means, the assessment results to provide a respective set of emotional competency developmental requirements; communicating the set of developmental requirements to the respective at least one customer-contact participant; developing, with participation of the at least one customer-contact participant and using the respective set of emotional competency developmental requirements, a respective learning contract comprising a set of learning activities selected from a matrix of available learning activities suitable to provide for learning of enhanced skill or proficiency in at least one developmental requirement of the respective set of developmental requirements; directing the at least one customer-contact participant to at least one contract learning activity to provide for learning, by the at least on customer-contact participant, of enhanced skill or proficiency in at least one developmental requirement of the respective set of developmental requirements; applying, by the at least one customer-contact participant, the enhanced skill or proficiency to the at least one customer-contact job-task, wherein at least one of establishing enhanced customer satisfaction and customer loyalty is, at least in part, afforded, and wherein said applying comprises facilitation by at least one Human learning transference expert having expert knowledge in promoting transference of the enhanced skill or proficiency to the at least one customer contact job-task.

In certain embodiments of this method, facilitation, by the at least one Human learning transference expert, of the application of the enhanced skill or proficiency to the at least one customer contact job-task comprises assembling a plurality of participants in a group to discuss successful strategies, progress or obstacles in the application of the enhanced skill or proficiency to the at least one customer contact job-task. In some embodiments, facilitation, by the at least one Human learning transference expert, of the application of the enhanced skill or proficiency to the at least one customer contact job-task comprises reducing or eliminating impediments or obstacles to said application that are inherent to the personnel management structure or to the managerial or supervisory relationship between the at least one managed or supervised customer-contact participant and the at least one managerial or supervisory participant who manages or supervises, or contributes to managing or supervising of the at least one customer-contact participant. In particular embodiments, facilitating by the at least one Human learning transference expert comprises evaluating, by the expert, the at least one customer-contact participant to identify at least one impediment or obstacle to application or learning transference of the enhanced skill or proficiency to the at least one customer contact job-task. In certain aspects, facilitating by the at least one Human learning transference expert additionally comprises evaluating or confronting at least one managerial or supervisory participant with respect to the at least one identified impediment or obstacle to learning transference of the acquired skill or proficiency results. Preferably, facilitating by the at least one Human learning transference expert comprises separately evaluating the at least one customer-contact participant and the at least one managerial or supervisory participant to promote candor.

In certain embodiments, the at least one impediment or obstacle to application or learning transference of the enhanced skill or proficiency to the at least one customer contact job-task comprises inflexibility or non-compliant or non-supportive behavior by the at least one managerial or supervisory participant.

In preferred embodiments of the method, at least one of obtaining authorization or endorsement, assessing using the emotional competency assessment means, evaluating, with assistance of Human assessment means expert, communicating the set of developmental requirements, developing a learning contract, directing the participant to at least contract learning activity, and applying the enhanced skill or proficiency to the at least one customer-contact job-task, is additionally with respect to the at least one managerial or supervisory participant.

In particular embodiments, the emotional competency assessment means expert and the learning transference expert are the same Human expert. In alternate embodiments, the emotional competency assessment means expert and the learning transference expert are different Human experts.

In particular embodiments, the at least one contract learning activity comprises at least one activity selected from the group consisting of workshops and self-directed activities. In some embodiments, the workshops comprise training in at least one skill area selected from the group consisting of empathy, listening and empathic listening, stress tolerance, stress management, impulse control, assertiveness, conflict resolution, and connecting to the customer. In certain embodiments, the self-directed learning activities comprise training in at least one skill area selected from the group consisting of emotional self-awareness, self-actualization, flexibility, and problem solving.

In particular embodiments, assessing using an emotional competency assessment means comprises use of at least one means selected from the group consisting of BarOn EQ-i®, MSCEIT™ and ECI™, as defined herein. Preferably, assessing using an emotional competency assessment means comprises use of the BarOn EQ-i®, as defined herein. In certain aspects, assessing using the assessment means comprises on-line use of a computer interface. In particular embodiments, assessing using the assessment tool comprises use of a local area network (LAN) or a wide-area network (WAN).

While the present invention has been particularly described with respect to a preferred steps in the method of the instant invention, it will be understood that the invention is not limited to the exemplary steps or best mode as described in the specification, and rather the scope of the present invention encompasses alternatives, modifications, and equivalents as may be included within the spirit and scope of the invention and as further defined by the appended claims.

In addition, although the best mode is practiced using the BAR-ON EQI™ emotional competency assessment means (tool), other equivalent assessment means, including the alternate exemplary assessment means recited herein above may be employed alone or in combination with the BAR-ON EQI™ in practicing the methods of the instant invention.

### EXAMPLE 1

### The Present Methods were used to Substantially Enhance External and Internal Customer Satisfaction and/or Loyalty with Respect to a Major Hotel Business

Particular aspects of the present invention provide novel methods to enhance customer loyalty. This Example illustrates how the present inventive methods were implemented in the context of a major hotel business to achieve substantial gains in customer satisfaction and customer loyalty. This Example further illustrated how the present inventive methods effectively overcame corporate culture-related obstacles to ‘learning transference’ in affecting the improvements in customer satisfaction and customer loyalty.

Implementation of the Method:

The present methods were implemented in 4 casino hotels (Caesar's, Atlantic City) for the respective ‘front desk’ employees (customer-contact participants). All other departments in the hotels: food and beverage, housekeeping, maintenance, casino operations, etc., were not exposed to the inventive loyalty-creating methods. Briefly, endorsement was obtained from the management of the customer-driven entity to assess the customer-contact participants using an emotional competency assessment means-in this instance the BarOn EQ-i™. The customer-contact participants were assessed using the emotional competency assessment means to provide for respective assessment results, which were evaluated with assistance of Human assessment means expert having expert knowledge of the assessment means, to provide a respective set of emotional competency developmental requirements, which were communicated to the respective customer-contact participants. Respective learning contracts (comprising a set of learning activities selected from a matrix of available learning activities suitable to provide for learning of enhanced skill or proficiency in at least one developmental requirement of the respective set of developmental requirements) were developed with participation of the customer-contact participants using the respective set of emotional competency developmental requirements. The customer-contact participants were directed to contract learning activities to provide for learning of enhanced skill or proficiency in the developmental requirements. Finally, the enhanced skill or proficiency was applied (with face-to-face assistance (group meeting) of a Human learning transference expert having expert knowledge in promoting transference of the enhanced skill or proficiency to the customer contact job-tasks) by the customer-contact participants to the customer-contact job-tasks, resulting in enhanced customer satisfaction and customer loyalty (see results below).

Results of the Implementation:

Three months after completing the method (implementing the method), customer satisfaction scores (from customer surveys) in each of the hotels had increased by at least 20% over the pre-process scores. After one year, the front desk scores were again assessed (customer satisfaction scores from customer surveys), and it was determined that the front desk scores continued to increase, whereas the rest of the hotel departments actually went down. Finally, and significantly, not only external customer satisfaction was enhanced, but internal custumer satisfaction was also enhanced—as measure by a 15% lower front-desk employee turnover.

### EXAMPLE 2

### The Present Methods were used to Substantially Enhance Customer Satisfaction and/or Loyalty with Respect to a New York/New Jersey-Based Computer Sales and Service Company

This Example provides another exemplary implementation of particular aspects of the present invention. Specifically, this Example shows how the presently disclosed methods enhanced external customer satisfaction in a representative sales and service business having a customer base largely comprising restaurant purchasers of restaurant-customized computer equipment. The entity comprised customer-contact sales personnel who traveled to potential customer sites to sell product, as well as customer-contact service personnel who interacted via telephone with customers having computer problems, and who traveled (24/7) to sites to respond to problems and repair/service computer and related equipment.

Implementation of the Method:

A total of twenty personnel (9 sales personnel and 11 service personnel) were involved in the inventive method.

Briefly, as described above under Example 1, endorsement was obtained from the management of the customer-driven entity to assess the customer-contact participants using an emotional competency assessment means-in this instance the BarOn EQ-i™. The customer-contact participants were assessed using the emotional competency assessment means to provide for respective assessment results, which were evaluated with assistance of Human assessment means expert having expert knowledge of the assessment means, to provide a respective set of emotional competency developmental requirements, which were communicated to the respective customer-contact participants. Respective learning contracts (comprising a set of learning activities selected from a matrix of available learning activities suitable to provide for learning of enhanced skill or proficiency in at least one developmental requirement of the respective set of developmental requirements) were developed with participation of the customer-contact participants using the respective set of emotional competency developmental requirements. The customer-contact participants were directed (self-directed with expert facilitation) to contract learning activities, and goals were established (self-established with expert facilitation) to provide for learning of enhanced skill or proficiency in the developmental requirements. Finally, the enhanced skill or proficiency was applied (with face-to-face assistance (group meeting) of a Human learning transference expert having expert knowledge in promoting transference of the enhanced skill or proficiency to the customer contact job-tasks) by the customer-contact participants to the customer-contact job-tasks, resulting in enhanced customer satisfaction and customer loyalty (see results below).

Significantly, during implementation of the method it was necessary to overcome a significant learning transference impediment in terms of the personnel being too busy during the day to acquire and/or apply enhanced emotional competency learning, because of the highly demanding and busy work day of the personnel. Expert facilitators solved this problem by meeting with management personnel and obtaining the flexibility to schedule facilitation, workshops, etc, at 7:30 a.m. prior to commencement of the regular work day. Additionally, the entity responded providing incentives to its customer-contact personnel by paying them for attending the pre-work sessions.

Results of the Implementation:

Sixty days after application of the inventive method, the President of the subject sales and service entity, reported to the Applicant that: most of the entities customer-contact personnel were displaying significantly enhanced customer relation skills in relation to the customer base (e.g., fewer complaints); that the entity was receiving a significant amount of spontaneous praise from its customer base; and that the customer base was externally promoting the entity as gauged by referrals.

### EXAMPLE 3

### The Present Methods Were Used to Substantially Enhance Internal Customer Satisfaction and/or Loyalty With Respect to a Three-Restaurant Chain

This Example provides another exemplary implementation of particular aspects of the present invention. Specifically, this Example relates to business entity comprising an extremely busy three-restaurant chain in the Washington D.C. area, and shows how the inventive methods were used to enhance the internal customer satisfaction by implementation of the methods to management/supervisory personnel, but not to the managed staff personnel. The application results in a substantially decreased amount of employee turn-over, which is a substantial financial benefit in the restaurant business (in view of the costs of training new personnel). In this Example the ‘customers’ are internal customers corresponding to the supervised staff personnel in the three restaurants.

Implementation of the Method:

A total of twelve personnel (executive and senior management) were involved in the inventive method. Specifically, the President, Vice President, Training Director and the Director of Administration, along with the general managers and executive chefs of the three restaurants in the chain. In this Example the ‘customers’ are internal customers corresponding to the supervised staff personnel in the three restaurants of the chain (e.g., waiters, cooks, dish washers, bar tenders, maintenance personnel, etc.).

Briefly, as described above under Examples 1 and 2, endorsement was obtained from the management of the customer-driven entity to assess the customer-contact participants using an emotional competency assessment means-in this instance the BarOn EQ-i™. The customer-contact participants were assessed using the emotional competency assessment means to provide for respective assessment results, which were evaluated with assistance of Human assessment means expert having expert knowledge of the assessment means, to provide a respective set of emotional competency developmental requirements, which were communicated to the respective customer-contact participants. Respective learning contracts (comprising a set of learning activities selected from a matrix of available learning activities suitable to provide for learning of enhanced skill or proficiency in at least one developmental requirement of the respective set of developmental requirements) were developed with participation of the customer-contact participants using the respective set of emotional competency developmental requirements. The customer-contact participants were directed (self-directed with expert facilitation) to contract learning activities, and goals were established (self-established with expert facilitation) to provide for learning of enhanced skill or proficiency in the developmental requirements. Finally, the enhanced skill or proficiency was applied (with face-to-face assistance (group meeting) of a Human learning transference expert having expert knowledge in promoting transference of the enhanced skill or proficiency to the customer contact job-tasks) by the customer-contact participants to the customer-contact job-tasks, resulting in enhanced customer satisfaction and customer loyalty (see results below).

Results of the Implementation:

Sixty days after application of the inventive method, the President of the subject restaurant-based entity, reported to the Applicant that: most of the entities customer-contact personnel were displaying significantly enhanced staff relation skills (e.g., fewer complaints); that this was accompanied by a substantially decreased (40% lower) staff turnover among the three restaurants of the chain (i.e., substantially enhanced employee retention). The President commented that in the restaurant business, the staff-turn over problem was significant in view of the costs associated with breaking in and training new personnel, which, within this particular business model, amounted to a value in excess of U.S. $1,000.00 per staff employee.

1. A method for enhancing at least one of customer satisfaction and customer loyalty, comprising:
a) identifying a customer-driven entity having a personnel management structure and having participant personnel comprising at least one managed or supervised customer-contact participant having customer-contact job-tasks, and at least one managerial or supervisory participant who manages or supervises, or who contributes to managing or supervising of the at least one customer-contact participant;
b) assessing the at least one customer-contact participant, using an emotional competency assessment tool and with facilitation by at least one Human assessment tool expert having expert knowledge of the assessment tool, to provide for assessment results and a respective set of developmental requirements derived by the at least one assessment tool expert based on the emotional competency assessment results;
c) participating, by the at least one customer-contact participant, in at least one contract learning activity suitable to provide for learning of enhanced skill or proficiency in at least one developmental requirement of the respective set of developmental requirements; and
d) applying, by the at least one customer-contact participant, the enhanced skill or proficiency to the at least one customer-contact job-task, wherein at least one of establishing enhanced customer satisfaction and customer loyalty is, at least in part, afforded, and wherein said applying comprises facilitation by at least one Human learning transference expert having expert knowledge in promoting transference of the enhanced skill or proficiency to the at least one customer contact job-task.

2. The method of claim 1, wherein facilitation in d), by the at least one Human learning transference expert, comprises assembling a plurality of participants in a group to discuss successful strategies, progress or obstacles in the application of the enhanced skill or proficiency to the at least one customer contact job-task.

3. The method of claim 1, wherein facilitation in d), by the at least one Human learning transference expert, of the application of the enhanced skill or proficiency to the at least one customer contact job-task comprises reducing or eliminating impediments or obstacles to said application that are inherent to the personnel management structure or to the managerial or supervisory relationship between the at least one managed or supervised customer-contact participant and the at least one managerial or supervisory participant who manages or supervises, or contributes to managing or supervising of the at least one customer-contact participant.

4. The method of claim 3, wherein facilitating in d) by the at least one Human learning transference expert comprises evaluating, by the expert, the at least one customer-contact participant to identify at least one impediment or obstacle to application or learning transference of the enhanced skill or proficiency to the at least one customer contact job-task.

5. The method of claim 4, wherein facilitating in d) by the at least one Human learning transference expert further comprises evaluating or confronting at least one managerial or supervisory participant with respect to the at least one identified impediment or obstacle to learning transference of the acquired skill or proficiency results.

6. The method of claim 5, wherein facilitating in d) by the at least one Human learning transference expert comprises separately evaluating the at least one customer-contact participant and the at least one managerial or supervisory participant to promote candor.

7. The method of claim 3, wherein the at least one impediment or obstacle to application or learning transference of the enhanced skill or proficiency to the at least one customer contact job-task comprises inflexibility or non-compliant or non-supportive behavior by the at least one managerial or supervisory participant.

8. The method of claim 1, further comprising, prior to participating in c), communicating the set of developmental requirements to the respective at least one customer-contact participant.

9. The method of claim 8, further comprising, prior to participating in c) and after communicating, developing a respective learning contract for the at least one customer-contact participant, the learning contract comprising a set of learning activities selected from a matrix of available learning activities suitable to provide for learning of enhanced skill or proficiency in at least one developmental requirement of the respective set of developmental requirements.

10. The method of claim 9, wherein developing a respective learning contract for the at least one customer-contact participant is by, or comprises input from the at least one customer-contact participant and using the respective set of developmental requirements.

11. The method of claim 9, wherein developing a respective learning contract for the at least one customer-contact participant is by, or comprises assistance from a Human learning contract expert having expert knowledge of the learning activities and using the respective set of developmental requirements.

12. The method of claim 9, further comprising, after developing the learning contract, directing the at least one customer-contact participant to at least one contract learning activity of the set of learning activities to provide for learning of enhanced skill or proficiency in the at least one developmental requirement of the respective set of developmental requirements.

13. The method of claim 12, wherein directing the at least one customer-contact participant to the at least one contract learning activity is self-directing by the at least one customer-contact participant.

14. The method of claim 12, wherein directing the at least one customer-contact participant to the at least one contract learning activity is by, or assisted by a Human contract learning activity expert having expert knowledge of the relevance or value of the at least one contract learning activity to the at least one developmental requirement.

15. The method of claim 1, wherein at least one of assessing in b), participating in c) and applying in d) is additionally with respect to the at least one managerial or supervisory participant.

16. The method of claim 1, further comprising prior to assessing in a), obtaining authorization or endorsement from the customer-driven entity to assess the at least one customer-contact participant using the emotional competency assessment tool.

17. The method of claim 16, where obtaining authorization or endorsement additionally comprises obtaining authorization or endorsement from the customer-driven entity to assess the at least one managerial or supervisory participant, and wherein at least one of assessing in b), participating in c) and applying in d) is additionally with respect to the at least one managerial or supervisory participant.

18. The method of claim 1, wherein the assessment tool expert and the learning transference expert are the same Human expert.

19. The method of claim 1, wherein the assessment tool expert and the learning transference expert are different Human experts.

20. The method of claim 11, wherein the assessment tool expert, learning transference expert and contract learning activity expert are the same Human expert.

21. The method of claim 11, wherein at least two from among the assessment tool expert, learning transference expert and contract learning activity expert are the same or different Human experts.

22. The method of claim 1, wherein the at least one contract learning activity comprises at least one activity selected from the group consisting of workshops and self-directed activities.

23. The method of claim 22, wherein the workshops comprise training in at least one skill area selected from the group consisting of empathy, listening and empathic listening, stress tolerance, stress management, impulse control, assertiveness, conflict resolution, connecting to the customer, and goal setting.

24. The method of claim 22, wherein the self-directed learning activities comprise training in at least one skill area selected from the group consisting of emotional self-awareness, self-actualization, flexibility, and problem solving.

25. The method of claim 1, wherein the at least one contract learning activity comprises developing at least one goal for application, by the at least one customer-contact participant, of the enhanced skill or proficiency in at least one developmental requirement to the respective customer-contact job-tasks.

26. The method of claim 25, wherein at least one of developing the at least one goal and achieving the at least one goal comprises participation by the at least one managerial or supervisory participant.

27. The method of claim 25, wherein developing the at least one goal for the at least one customer-contact participant is by, or assisted by a Human contract learning activity expert having expert knowledge of the relevance or value of the at least one contract learning activity to the at least one developmental requirement or to the respective customer-contact job-tasks.

28. The method of claim 25, wherein the at least one goal is set pursuant to a motivational reward system to facilitate goal achievement.

29. The method of claim 28, wherein the at least one goal is shared by the at least one managerial or supervisory participant to facilitate goal achievement.

30. The method of claim 22, comprising developing, in the workshops and/or self-directed activities, goals for application, by the at least one customer-contact participant, of the enhanced skill or proficiency in at least one developmental requirement to the respective customer-contact job-tasks.

31. The method of claim 17, wherein obtaining authorization or endorsement additionally comprises explaining at least one of assessing in b), participating in c) and applying in d) to the at least one managerial or supervisory participant and to the at least one managed or supervised customer-contact participant to facilitate application or learning transference of the enhanced skill or proficiency in at least one developmental requirement to the respective customer-contact job-tasks.

32. The method of claim 16, wherein obtaining authorization or endorsement additionally comprises explaining, to the at least one customer-contact participant, guidelines for emotional competency assessment using an emotional competency assessment tool.

33. The method of claim 1, wherein assessing using an emotional competency assessment tool comprises use of at least one means selected from the group consisting of BarOn EQ-i®, MSCEIT™ and ECI™, as defined herein.

34. The method of claim 33, wherein assessing using an emotional competency assessment tool comprises use of the BarOn EQ-i®, as defined herein.

35. The method of claim 1, wherein assessing using the assessment tool comprises on-line use of a computer interface.

36. The method of claim 1, wherein assessing using the assessment tool comprises use of a local area network (LAN) or a wide-area network (WAN).

37. The method of claim 1, wherein facilitation by the at least one Human assessment tool expert or the at least one Human learning transference expert is in real-time.

38. The method of claim 37, wherein the real-time facilitation means comprises, with respect to the personnel participant, face-to-face interaction, telephonic interaction, video-conference interaction, interactive real-time computer (e.g., LAN or WAN) dialog, or combinations thereof.

39. The method of claim 1, wherein facilitation by the at least one Human assessment tool expert or the at least one Human learning transference expert is not in real-time or is non-contemporaneous.

40. The method of claim 39, wherein the non real-time or non-contemporaneous facilitation means comprises, with respect to the personnel participant, audio, video, written or graphic media.

41. A method for enhancing at least one of customer satisfaction and customer loyalty, comprising:
identifying a customer-driven entity having a management and having participant personnel comprising at least one managed or supervised customer-contact participant having customer-contact job-tasks, and at least one managerial or supervisory participant who manages or supervises, or who contributes to managing or supervising of the at least one customer-contact participant;
obtaining authorization or endorsement from the management of the customer-driven entity to assess the at least one customer-contact participant using an emotional competency assessment means;
assessing, using the emotional competency assessment means, the at least one customer-contact participant to provide for respective assessment results;
evaluating, with assistance of Human assessment means expert having expert knowledge of the assessment means, the assessment results to provide a respective set of emotional competency developmental requirements;
communicating the set of developmental requirements to the respective at least one customer-contact participant;
developing, with participation of the at least one customer-contact participant and using the respective set of emotional competency developmental requirements, a respective learning contract comprising a set of learning activities selected from a matrix of available learning activities suitable to provide for learning of enhanced skill or proficiency in at least one developmental requirement of the respective set of developmental requirements;
directing the at least one customer-contact participant to at least one contract learning activity to provide for learning, by the at least on customer-contact participant, of enhanced skill or proficiency in at least one developmental requirement of the respective set of developmental requirements;
applying, by the at least one customer-contact participant, the enhanced skill or proficiency to the at least one customer-contact job-task, wherein at least one of establishing enhanced customer satisfaction and customer loyalty is, at least in part, afforded, and wherein said applying comprises facilitation by at least one Human learning transference expert having expert knowledge in promoting transference of the enhanced skill or proficiency to the at least one customer contact job-task.

42. The method of claim 41, wherein facilitation, by the at least one Human learning transference expert, of the application of the enhanced skill or proficiency to the at least one customer contact job-task comprises assembling a plurality of participants in a group to discuss successful strategies, progress or obstacles in the application of the enhanced skill or proficiency to the at least one customer contact job-task.

43. The method of claim 41, wherein facilitation, by the at least one Human learning transference expert, of the application of the enhanced skill or proficiency to the at least one customer contact job-task comprises reducing or eliminating impediments or obstacles to said application that are inherent to the personnel management structure or to the managerial or supervisory relationship between the at least one managed or supervised customer-contact participant and the at least one managerial or supervisory participant who manages or supervises, or contributes to managing or supervising of the at least one customer-contact participant.

44. The method of claim 43, wherein facilitating by the at least one Human learning transference expert comprises evaluating, by the expert, the at least one customer-contact participant to identify at least one impediment or obstacle to application or learning transference of the enhanced skill or proficiency to the at least one customer contact job-task.

45. The method of claim 44, wherein facilitating by the at least one Human learning transference expert additionally comprises evaluating or confronting at least one managerial or supervisory participant with respect to the at least one identified impediment or obstacle to learning transference of the acquired skill or proficiency results.

46. The method of claim 45, wherein facilitating by the at least one Human learning transference expert comprises separately evaluating the at least one customer-contact participant and the at least one managerial or supervisory participant to promote candor.

47. The method of claim 43, wherein the at least one impediment or obstacle to application or learning transference of the enhanced skill or proficiency to the at least one customer contact job-task comprises inflexibility or non-compliant or non-supportive behavior by the at least one managerial or supervisory participant.

48. The method of claim 41, wherein at least one of obtaining authorization or endorsement, assessing using the emotional competency assessment means, evaluating, with assistance of Human assessment means expert, communicating the set of developmental requirements, developing a learning contract, directing the participant to at least contract learning activity, and applying the enhanced skill or proficiency to the at least one customer-contact job-task, is additionally with respect to the at least one managerial or supervisory participant.

49. The method of claim 41, wherein the emotional competency assessment means expert and the learning transference expert are the same Human expert.

50. The method of claim 41, wherein the emotional competency assessment means expert and the learning transference expert are different Human experts.

51. The method of claim 41, wherein the at least one contract learning activity comprises at least one activity selected from the group consisting of workshops and self-directed activities.

52. The method of claim 51, wherein the workshops comprise training in at least one skill area selected from the group consisting of empathy, listening and empathic listening, stress tolerance, stress management, impulse control, assertiveness, conflict resolution, and connecting to the customer.

53. The method of claim 51, wherein the self-directed learning activities comprise training in at least one skill area selected from the group consisting of emotional self-awareness, self-actualization, flexibility, and problem solving.

54. The method of claim 41, wherein assessing using an emotional competency assessment means comprises use of at least one means selected from the group consisting of BarOn EQ-i®, MSCEIT™ and ECI™, as defined herein.

55. The method of claim 53, wherein assessing using an emotional competency assessment means comprises use of the BarOn EQ-i®, as defined herein.

56. The method of claim 41 wherein assessing using the assessment means comprises on-line use of a computer interface.

57. The method of claim 41, wherein assessing using the assessment tool comprises use of a local area network (LAN) or a wide-area network (WAN).

58. The method of claim 41, wherein facilitation by the at least one Human assessment means expert or the at least one Human learning transference expert is in real-time.

59. The method of claim 58, wherein the real-time facilitation means comprises, with respect to the personnel participant, face-to-face interaction, telephonic interaction, video-conference interaction, interactive real-time computer (e.g., LAN or WAN) dialog, or combinations thereof.

60. The method of claim 41, wherein facilitation by the at least one Human assessment means expert or the at least one Human learning transference expert is not in real-time or is non-contemporaneous.

61. The method of claim 60, wherein the non real-time or non-contemporaneous facilitation means comprises, with respect to the personnel participant, audio, video, written or graphic media.

62. A training kit for enhancing emotional competence and customer satisfaction and loyalty, comprising descriptive material, including audio media, for at least one emotional competency learning activity, wherein the descriptive material additionally describes how to implement the learning activity in the method according to claim 1.
